(19) United States
(12) Patent Application Publication
(10) Pub. No.: US 2015/0054335 A1
(43) Pub. Date: Feb. 26, 2015

(54) Weighted Track for Snowmobiles

(71) Applicant: Paul Krull, Wasilla, AK (US)

(72) Inventor: Paul Krull, Wasilla, AK (US)

(21) Appl. No.: 13/608,147

(22) Filed: Sep. 10, 2012

(51) Int. Cl. B62D 55/24

(52) U.S. Cl. 305/178

(57) ABSTRACT

A weighted track system for snowmobiles. In one embodiment, the rider uses a heavier track to add weight useful in trick jumps. This track is installed prior to jumping and can be used for regular riding. In a second embodiment, weights are added to an existing track to provide the additional momentum. The weights are installed at regular intervals on the track and can be adjustable so that more or less weight can be added as desired. With a weighted track, perfect timing in locking up the brakes while jumping is not s critical; making the performance in jumps is safer and better.

### CROSS REFERENCE TO RELATED APPLICATIONS

Not Applicable

### STATEMENT REGARDING FEDERALLY SPONSORED RESEARCH AND DEVELOPMENT

Not Applicable

### BACKGROUND OF THE INVENTION

1. Field of the Invention

This invention relates to snowmobile tracks and particularly to weighted snowmobile tracks

2. Description of the Prior Art

Today, snowmobiles are used for more than just trail riding. A relatively new sport—freestyle sno-cross is becoming more and more popular. Freestyle sno-cross is more than just going off a ramp. Riders now attempt to do multiple flips—both front flips and back flips while performing jumps.

Doing such flips requires exact timing as the flips are caused by conservation of angular momentum. Essentially, a rider runs a snowmobile at high speed up a ramp. At the top of the ramp, the rider engages the brakes to stop the track. This action causes the snowmobile to flip, depending on certain factors, either forward or backward, while still being propelled forwards and upwards.

One key factor to doing flips successfully—and multiple flips in particular—is the weight of the track. A heavier track carries more momentum that a lighter track. More momentum equates to more and better flips, for example, double front flips and triple back flips are now possible using this weight system.

### BRIEF DESCRIPTION OF THE INVENTION

The instant invention provides a way to gain additional momentum. In one embodiment, the rider uses a heavier track. This track is installed prior to jumping and is normally removed (but can be used) for regular riding. In a second embodiment, weights are added to an existing track to provide the additional momentum. The weights are installed at regular intervals on the track and can be adjustable so that more or less weight can be added as desired. With a weighted track, perfect timing in locking up the brakes is not as critical; making the performance in jumps is safer and better.

### BRIEF DESCRIPTION OF THE DRAWINGS

FIG. 1 is a detail view of a portion of a heavier weighted track.

FIG. 2 is an exploded side view of the preferred embodiment of a portion of a weighted track for snowmobiles.

FIG. 3 is a top plan view of the inside portion of a track for snowmobiles that has the weight system attached.

FIG. 4 is a top plan view of the outer portion of a track for snowmobiles that has the weight system attached.

FIG. 5 is a side exploded view of an alternative embodiment for adding weight to a snowmobile track.

FIG. 6 is a top plan view of the alternative embodiment of FIG. 5.

### DETAILED DESCRIPTION OF THE INVENTION

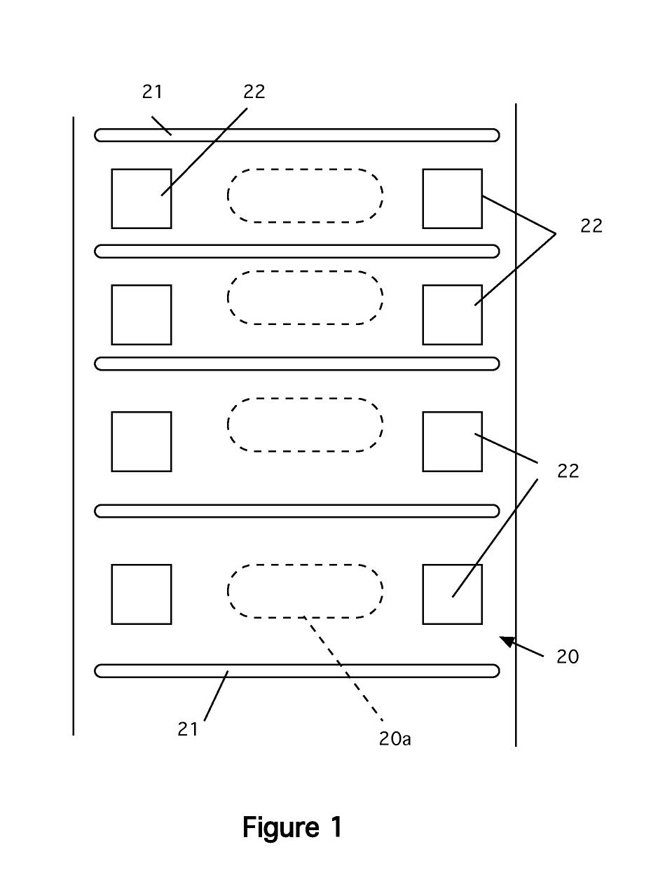

In this invention 10, is the invention is a track 20 that has a higher weight than a normal track. Such a track can be made using standard techniques but adding additional weight—represented by the dashed ovals labeled 20a—to the track during manufacturing. FIG. 1 is a detail view of a portion of a heavier weighted track 20. The track 20 is typically 15 inches wide and has paddles 21 and holes 22 for the driver. In the preferred embodiment, the track has a weight of between 32 and 45 pounds depending on the size of the track. For example, a 15″×121″ (short track) with a 1″ paddle weighs about 32 lbs; the same track with a 2″ paddle weighs about 45 lbs.

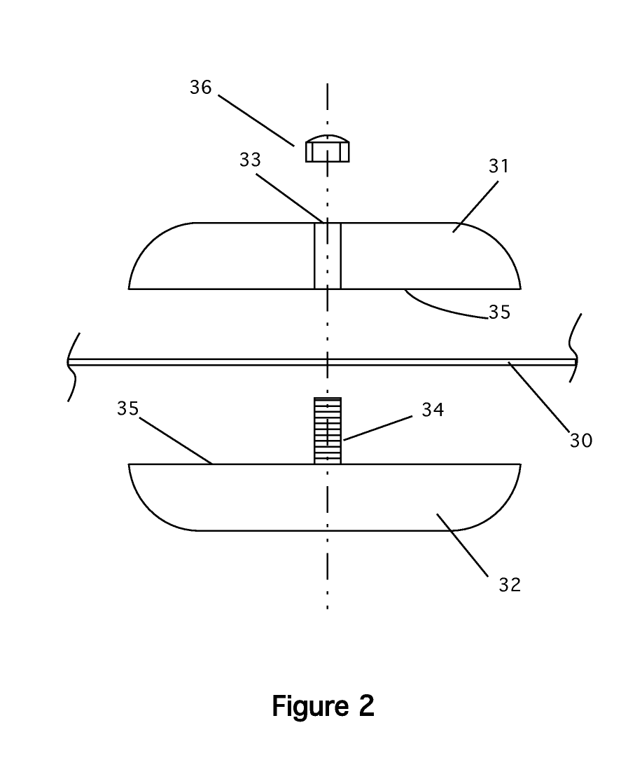

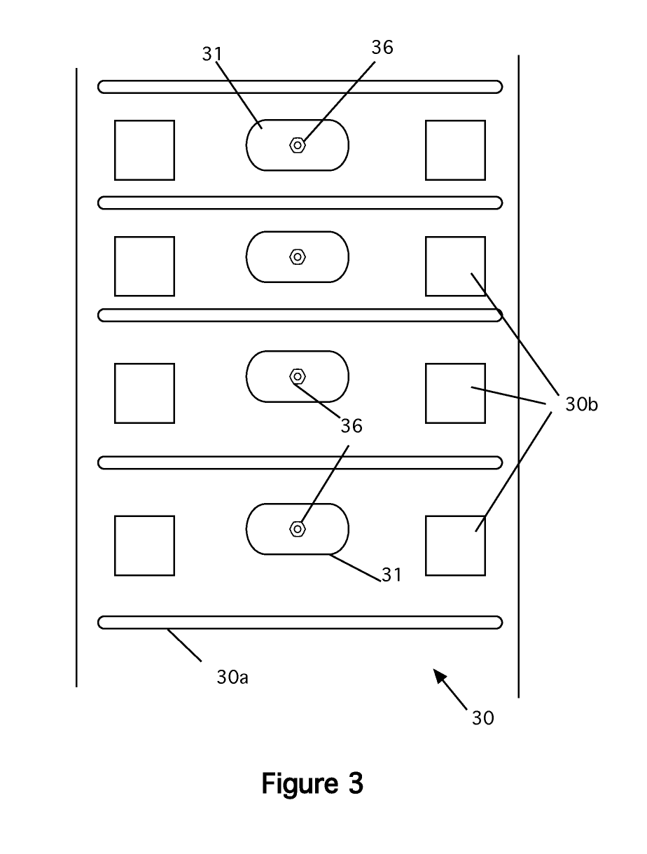

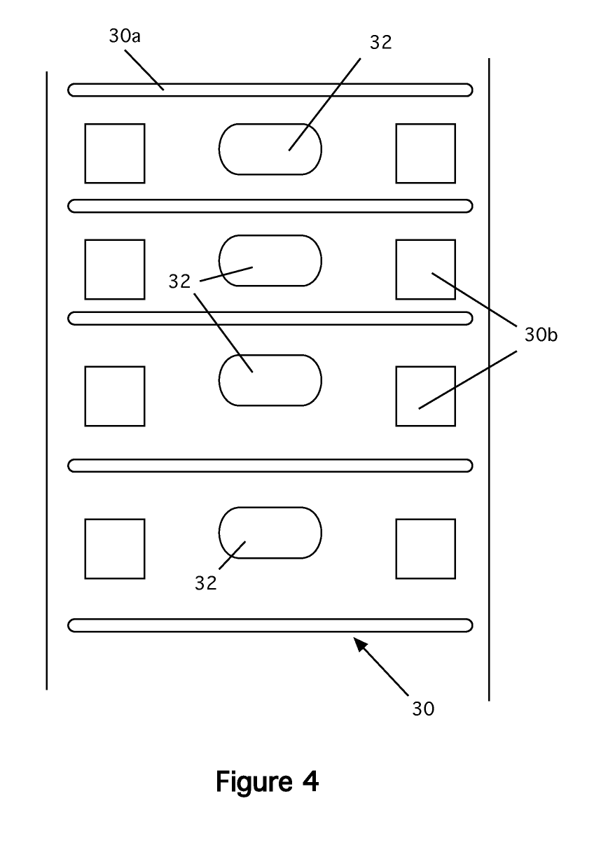

In addition to the heavier track, a standard weight track that has weights added to it is possible. FIG. 2 is an exploded side view of the preferred embodiment of a portion of a weighted track for snowmobiles. The track 30 is positioned between two weights 31 and 32, which are attached to the track between the paddles through holes formed in the track (see FIGS. 3 and 4). As shown in FIG. 2, in the preferred embodiment, the inner weight 31 is about ¾ inches high, 1 inch wide and about 4 inches long. The preferred dimensions are chosen to ensure that the weights do not interfere with the normal operation of the track. A hole 33 is drilled in the center to accommodate the threaded stud 34 from the outer weight 32. In the preferred embodiment, the threaded stud 34 is ⅜ inches. Both weights can be chromed for marketing purposes. Both weights have slightly crowned surfaces 35 that contact the track. These surfaces are designed to reduce friction in rotation and reduce track wear. Both weights are secured to the track with a locknut 36. In the preferred embodiment, this nut is a NYLOCK style locknut that has a strength rating to grade 8.

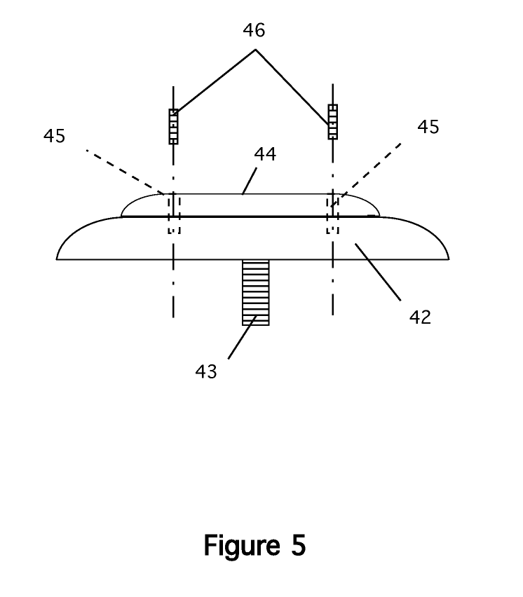

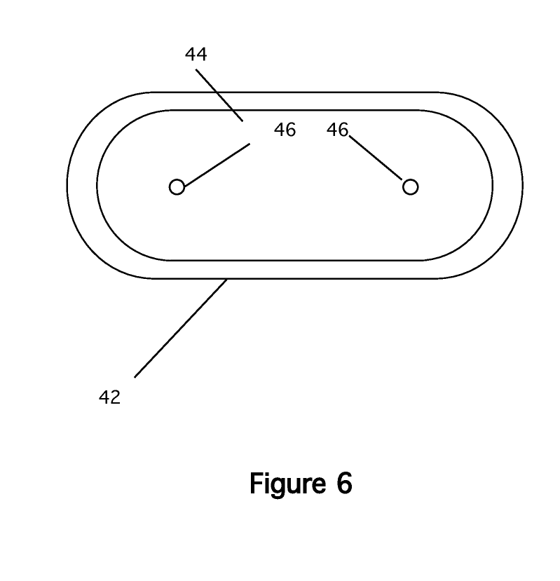

FIG. 3 is a top plan view of the inner surface of a portion of a track 30 for snowmobiles. As before, the track 30 has paddles 30a and holes 30b for the driver. Here, the weights 31 are shown bolted in place with locknuts 36. One advantage of the system is that the user can add more or less weight as desired. For example, weight can be adjusted when doing a front flip as opposed to doing a back flip. (See FIGS. 5 and 6 for another alternative). As shown, preferably, the weights are distributed around the entire track to provide uniform weight distribution based on several factors, including riding style, rider size, machine size and the desired trick being attempted.

FIG. 4 is a top plan view of the outer portion of a track for snowmobiles that has the weight system attached. Here, the outer weights 32 are shown in place on the track 30.

As noted above, one advantage of the system is that the user can add more or less weight as desired. One way to do this is by using different weight amounts for units 31 and 32 in different parts of the track. Another way to do this is be adding additional weight to the outer weight 32 in selected places. FIG. 5 is a side exploded view of an alternative embodiment for adding weight to a snowmobile track. Here, an outer weight 42 is shown with the stud 43 that attaches to the inner weight and nut as before. The size of the weight 42 is smaller that that of FIG. 2 to accommodate adding additional weight. An auxiliary outer weight 44 is shown positioned above weight 42. Both weights 42 and 44 have two holes 45 to receive setscrews 46 as shown. These holes receive the setscrews 46 to secure the auxiliary outer weight 44 to the outer weight 42. Note, the weight 42 can be used with or without the auxiliary outer weight 44.

FIG. 6 is a top plan view of the alternative embodiment of FIG. 5 showing weights 42 and 44 and set screws 46 in position.

The present disclosure should not be construed in any limited sense other than that limited by the scope of the claims having regard to the teachings herein and the prior art being apparent with the preferred form of the invention disclosed herein and which reveals details of structure of a preferred form necessary for a better understanding of the invention and may be subject to change by skilled persons within the scope of the invention without departing from the concept thereof.

I claim:

1. A snowmobile track for use in trick jumps comprising:
a) an endless track having a weight of between about 32 and 45 pounds, a plurality of paddles and a plurality of drive holes.

2. A snowmobile track for use in trick jumps comprising:
a) an endless track having an inner surface and a plurality of paddles positioned about an outer surface of said track at spaced apart intervals;
b) a plurality of inner weights each of said plurality of inner weights having at least one hole formed therein;
c) a plurality of outer weights, each of said plurality of outer weights having a threaded stud formed thereon, one of said plurality of outer weights being aligned with one of said inner weights such that the threaded stud on said outer weight engages the hole in said inner weight and further wherein when the threaded stud on said outer weight engages the hole in said inner weight, said outer weight is positioned against the outer surface of said track and the inner weight is positioned against said inner surface of said track; and
d) a means for locking one inner weights and one outer weight together.

3. The snowmobile track of claim 2 wherein the means for locking said inner weight and said outer weight together comprises a lock nut, threadably secured on the threaded stud to secure said inner and outer weights in place.

4. The snowmobile track of claim 2 wherein each of said plurality of said outer weights has at least one hole formed therein.

5. The snowmobile track of claim 4 wherein the at least one hole is threaded.

6. The snowmobile track of claim 5 further comprising:
a) a plurality of auxiliary outer weights having a flat bottom and at least one hole formed therein, said at least one hole aligning with at least one hole formed in each of said plurality of outer weights when said one of said auxiliary outer weights is placed atop one of said plurality of outer weights; and
b) a means for screwably securing said auxiliary outer weight to said outer weight.

7. The snowmobile track of claim 6 wherein the means for screwably securing said auxiliary outer weight comprises at least one setscrew threaded into said at least one hole in said outer weight.

8. The snowmobile track of claim 2 wherein each of said plurality of outer weights is positioned between two of said plurality of paddles.

9. A snowmobile track for use in trick jumps comprising:
a) an endless track having an inner surface and a plurality of paddles positioned about an outer surface of said track at spaced apart intervals;
b) a plurality of weights each of said plurality of weights; and
d) a means for securing each of said plurality of weights to said endless track.

10. The snowmobile track for use in trick jumps of claim 9 wherein said plurality of weights is attached to said inner surface of said endless track.

11. The snowmobile track for use in trick jumps of claim 9 wherein said plurality of weights is attached to said outer surface of said endless track.

12. The snowmobile track of claim 9 wherein the means for securing each of said plurality of weights to said endless track comprises a lock nut threadably secured on a threaded stud attached to each of said plurality of weights.

13. The snowmobile track of claim 11 further comprising:
a) a plurality of auxiliary outer weights having a flat bottom and at least one hole formed therein, said at least one hole aligning with at least one hole formed in each of said plurality of outer weights when said one of said auxiliary outer weights is placed atop one of said plurality of outer weights; and
b) a means for screwably securing said auxiliary outer weight to said outer weight.

14. The snowmobile track of claim 13 wherein the means for screwably securing said auxiliary outer weight comprises at least one setscrew threaded into said at least one hole in said outer weight.

15. The snowmobile track of claim 11 wherein each of said plurality of outer weights is positioned between two of said plurality of paddles.
